(19) United States
(12) Patent Application Publication
(10) Pub. No.: US 2007/0068402 A1
(43) Pub. Date: Mar. 29, 2007

(54) Method and apparatus for printing images having fraud detection features

(75) Inventors: Luis A. Sanchez, Hamden, CT (US); Robert A. Cordery, Danbury, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/235,630

(22) Filed: Sep. 26, 2005

(51) Int. Cl. B41J 1/00

(52) U.S. Cl. 101/93.42

(57) ABSTRACT

A method for incorporating fraud detection features in a printed image. The method includes the steps of providing an impact printer having a plurality of impact pins for producing pixels on a substrate, developing an encoding scheme within the printed image, and controlling the impact printer to produce the pixels in accordance with the encoding scheme. More specifically, the encoding scheme is characterized by predefining a group of pixels within the printed image and determining the pixel density characteristics thereof, e.g., light or dark pixels. Furthermore, the impact printer is controlled to vary the magnetic flux density across each solenoid, thereby varying the impact pressure applied by the impact pins on the print ribbon. By selectively controlling the magnetic flux density at least some of the respective print densities of each of the respective printed pixels are different from each other to define an encoding scheme within the printed image. Variation in pixel density may be produced by changing the magnitude, pulse width or frequency of the voltage/pulse applied to the solenoids of the impact printer.

### TECHNICAL FIELD

This invention relates to fraud detection in printed images, and, more particularly, to a new and useful method and apparatus for printing images having characteristics/features which enable fraud detection and protection.

### BACKGROUND OF THE INVENTION

Advances in the art of photocopying, digital image scanning and digital printing have made it increasingly difficult distinguish between an original printed image and a photocopy or scanned-and-printed copy of the original image. These advances have widespread implications regarding secure documents/images including postage indicia, paper currency, bank/traveler checks and/or tickets for various events/entertainment. Inasmuch as such documents/images are assets having monetary value, it will be appreciated that they are vulnerable to counterfeiting by various alteration/copying techniques. To protect or secure these documents/images from such attacks, it is common to introduce “copy detection features” which produce changes relative to the original document/image in a manner that can be readily detected with a high degree of reliability and convenience.

One of the more common “copy detection features” may be found in bank or payroll checks wherein, if copied, a word such, as “VOID” of “COPY” appears prominently and/or repeatedly on the face of the copied check. Therein, a plurality of ink dots are combined to produce the readable message, however, the diameter of the dots are individually varied. That is, when scanned or reprinted (e.g., copied) the larger dots appear more prominent while the smaller dots become more diffuse or blend into the background. Accordingly, the larger dots can be arranged to prominently display the message to alarm an unsuspecting recipient that the check has been copied, i.e., is not authentic.

Another example of the use of copy detection features is seen in connection with a postage meter indicia. Such indicia are printed on a mailpiece as an indication that the appropriate postage has been paid. Indicia typically include textual information such as the class of mail, a postage meter serial number, and the postage amount. The indicium also includes graphic elements such as a logo which may be printed with copy detection features such as the use of an imbedded watermark. A watermark is a feature of the graphic element which either stands-out (i.e., is robust) or is washed-out (i.e., is fragile) when the image is copied. A robust watermark is pattern in the graphic image which remains prominent or detectable when the image is copied. A fragile watermark, on the other hand, is a pattern within the graphic image which changes measurably when copied, e.g., portions of the image may become distorted or disappear.

Printing watermark images can be costly inasmuch as the pixel array must be accurately imaged and relies solely on the contrast and brightness of the image. That is, there are no supplemental or additional physical characteristics to augment detection. Generally, it is desirable to include secondary detection characteristics to confirm that a printed image has, indeed, been copied. Furthermore, the use of laser or inkjet printers to produce these images are still amongst the most costly printing methods. Moreover, such printers may not be adapted to multi-part forms. Many applications use multi-sheet forms which incorporate pressure sensitive inks, i.e., ink-filled microspheres which burst upon the application of pressure, to provide instantaneous copies of an original. As such, impact printers, i.e., those which impact a top sheet of the multi-part form, must be employed to apply the necessary pressure through multiple sheets of the form.

A need, therefore, exists to provide a low-cost method for printing on a substrate, including printing on multi-part forms, which incorporates reliable and verifiable fraud detection features.

### SUMMARY OF THE INVENTION

A method is provided for incorporating fraud detection features in an original printed image. The method includes the steps of providing an impact printer having a plurality of impact pins for producing pixels on a substrate, developing an encoding scheme within the printed image, and controlling the impact printer to produce the pixels in accordance with the encoding scheme. More specifically, the encoding scheme is characterized by predefining a group of pixels within the printed image and determining the pixel density characteristics thereof, e.g., light or dark pixels. Furthermore, the impact printer is controlled to vary the magnetic flux density across each solenoid, thereby varying the impact pressure applied by the impact pins on the print ribbon. By selectively controlling the magnetic flux density, at least some of the respective print densities of each of the respective printed pixels are different from each other to define an encoding scheme within the original image. Variation in pixel density may be produced by changing the magnitude, pulse width or frequency of the voltage/pulse applied to the solenoids of the impact printer.

### BRIEF DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention. As shown throughout the drawings, like reference numerals designate like or corresponding parts.

FIG. 1 is a schematic of an impact printer having a plurality of impact pins for producing pixels on a substrate material.

FIG. 2 is a flow diagram of a method for incorporating fraud detection features in an original printed image using the impact printer.

FIG. 3 shows an image incorporating an encoding scheme characterized by pixels of varying pixel density.

FIG. 4 is a Table of binary data associated with each column of a print grid shown in FIG. 3.

FIG. 5 shows a histogram of voltage vs. time wherein the magnitude of voltage is varied to control the pixel density of the original printed image.

FIG. 6 shows a histogram of voltage vs. time wherein the pulse width of the voltage is varied to control the pixel density of the original printed image.

FIG. 7 shows a histogram of voltage vs. time wherein the voltage is frequency modulated to control the pixel density of the original printed image.

### DETAILED DESCRIPTION

The present invention describes a method for incorporating fraud detection features into an image produced by a dot-matrix impact printer. While the inventive method is described in the context of printing a character on a rectangular pixel grid, it should be appreciated that the teachings herein are equally applicable to any application wherein impact printing provides sufficient print quality and/or resolution to produce the image. In the context used herein, the term “image” means any graphic, picture, text, character or string of characters.

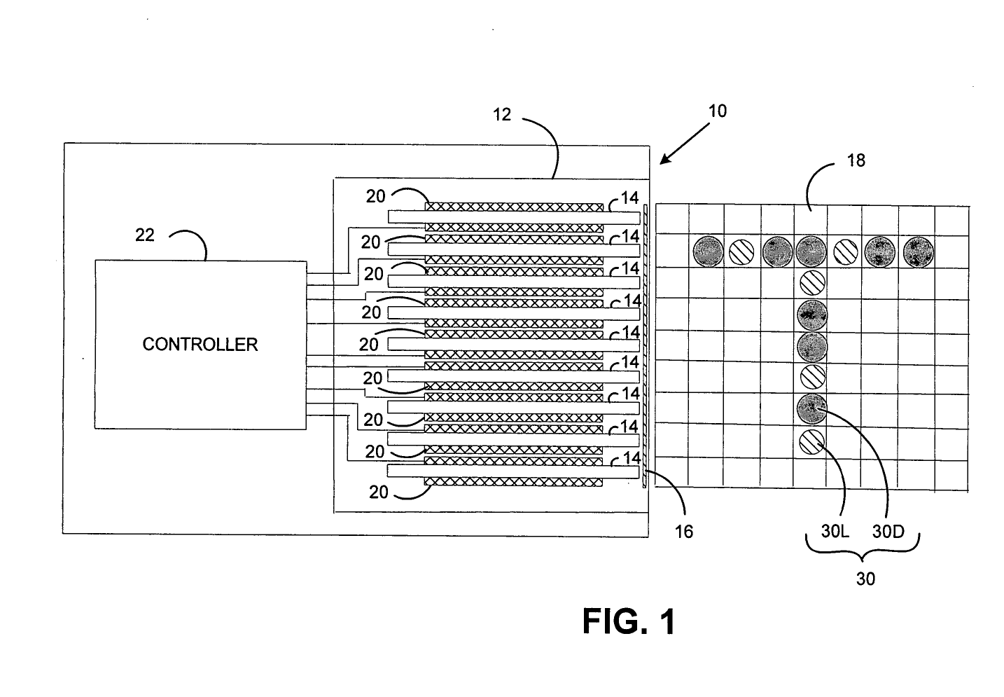

In FIG. 1, an impact printer 10 includes a print head 12 having an array of pins 14 and a print ribbon 16 interposing the print head 12 and a substrate material 18. Each of the pins 14 is disposed within an electrically activated solenoid 20 which generates an electrical field of sufficient strength to cause the pins 14 to displace linearly outwardly against the print ribbon 16. As the tip end of the pin 14 impacts the print ribbon 16 on one side, an ink dot 30 is produced on the other side, i.e., on the substrate material 18.

The pins 14 are generally orthogonal to the print ribbon 16 and are disposed in a closely-spaced linear array having one or more columns. In the described embodiment, the print head 12 includes a single column of nine (9) impact pins 14, though the invention may be employed with impact printers having a greater or fewer number of impact pins 14. The print head 12 is coupled to a controller 22 which coordinates the motion of the print head 12 with the selective activation of the solenoids 20/impact pins 14. More specifically, the controller 22 controls (i) the side-to-side motion of the print head 12, (ii) the magnetic flux density produced by the solenoids 20, i.e., the magnitude and/or length of pulse, and (iii) the timing of impact pin 14 displacement, to produce a plurality of ink dots 30 on the substrate 18.

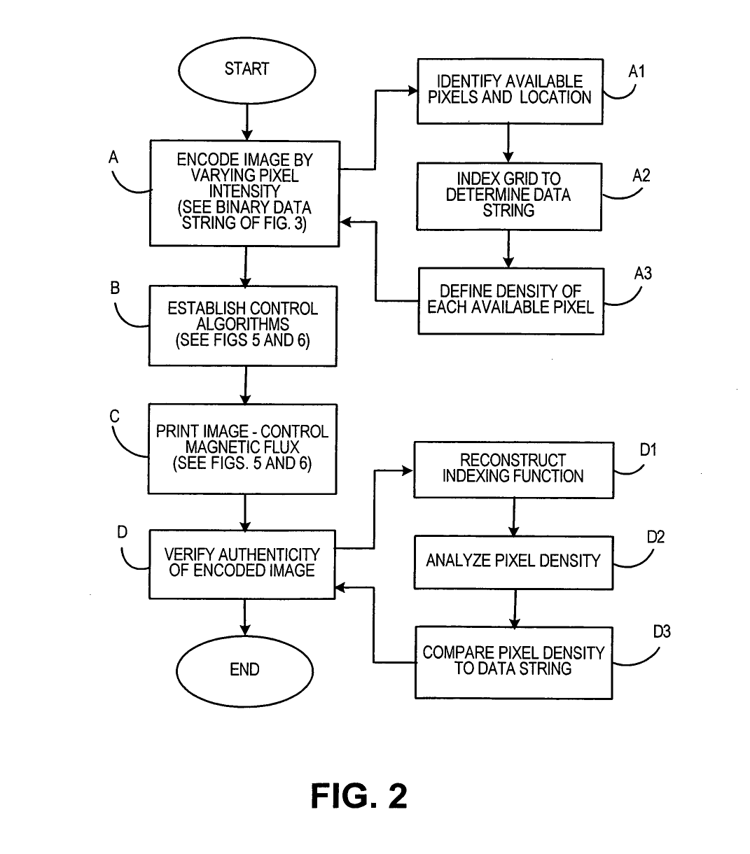

Having a general understanding of the operation of an impact printer 10, FIG. 2 describes a method of controlling the impact printer 10 to produce an image having fraud detection features. In the background of the invention, it will be recalled that fraud detection features may be introduced into an image to determine the authenticity of the printed image, i.e., whether the printed image, is valid or invalid.

In a first step A of the method, the image or, at least a portion of the image, is encoded. The encoding scheme constructs a binary string of data from a set of information within the image to define a recognizable or detectable pattern or symbol. The binary string of data can be a simple encoding of the information or could be derived cryptographically. The pattern or symbol may take the form of a graphic, picture, barcode, a character or character string.

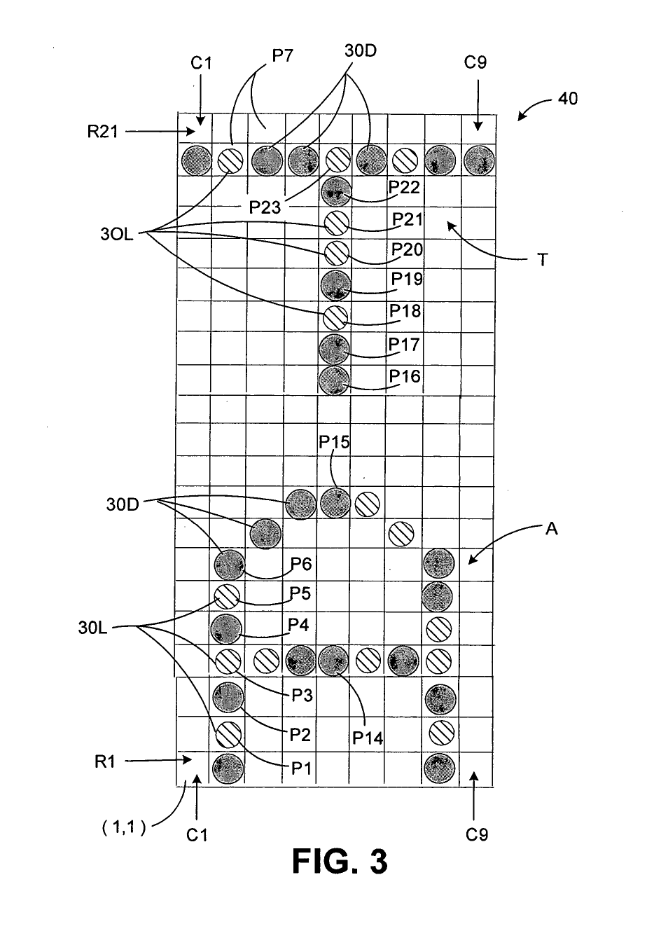

The encoding step includes the selection of various ink dots, or a pixels within a rectangular grid, which define a pattern or symbol within the image. In FIG. 3, an image 40 of characters “T” and “A” are shown having a predefined pattern of light and dark pixels 30L, 30D. The characters T, A are printed in a grid having nine (9) columns and twenty-two (21) rows. For reference purposes, the first space (1,1) in the lower left corner of the rectangular grid is located in the first column C1 and first row R1. The portion of the two character image 40 selected for encoding include any pixel which does not lie in columns or row along the periphery. Hence, any pixel in columns C1, C9 and rows R1, R21 is considered unavailable for encoding purposes. In column C2, seven (7) pixels P1-P7 are, therefore, available or considered part of the encoding scheme. Similarly, in column C5, ten (10) pixels P14-P23 are part of the encoding scheme 40. In total, thirty-seven (37) pixels are part of the two character encoded image 40.

In one encoding scheme, an indexing function may be employed and can proceed in accordance the substeps illustrated in FIG. 2. Initially, in step A1, the available pixels in the encoded portion of the image are identified in accordance with their location within a grid having X columns and Y rows. Furthermore, a number N is set to equal the total number of available pixels in the encoded portion of the image. As mentioned in the preceding paragraph the encoded image 40 of FIG. 3 is disposed in a grid having nine (9) columns, twenty-one (21) rows and has a total of thirty-seven (37) available pixels. In step A2, the print grid is indexed starting from the lower left corner, i.e., space (1, 1) with respect to the image 40 of FIG. 3. More specifically, indexing includes a progressive evaluation of the grid to establish the binary data string. This is performed by traversing the first column (1, y) where y is an integer from 1 to Y, then the second column (2, y), and so on through the last column (X, y).

Finally, in step A3, a binary number 0 or 1 is used to denote the density or darkness of a pixel. In a binary system, i.e., base two system, only two density levels are employed, hence, the numeral one (1) may denote a full density pixel e.g., black, while the numeral zero (0) can denote one-half the density level of black or fifty percent (50%) gray-scale. Of course, one may choose any integer base, i.e., a base three or four system, however, the same number of density variations must also be established for printing the available pixels

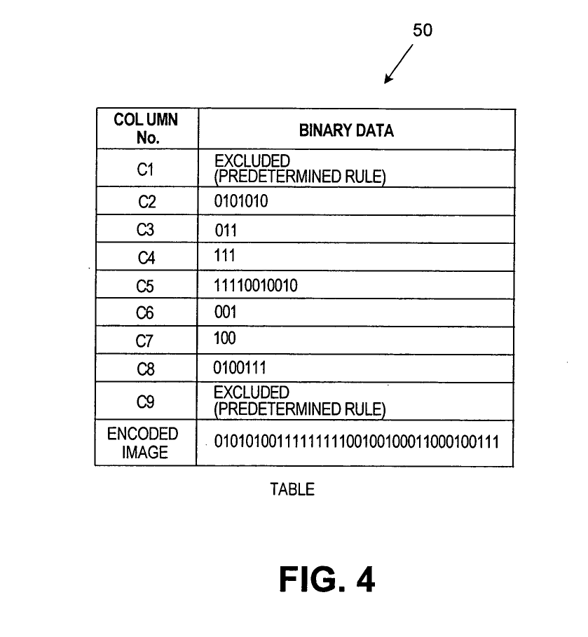

The binary data string reflecting the encoded portion of the image 40 is seen in the Table 50 of FIG. 4. Therein, columns C2-C8 of the grid yields binary data depending upon the number of available pixels in the column. In accordance with the predetermined rule that data in Columns C1 and C9 would be unavailable, no data is produced upon indexing the grid. The complete string of binary data for the encoded image 40 is the combined in the final row of the table. It is this binary string that, together with the rules of the indexing scheme, would be used by scanning equipment to verify the authenticity of the printed image. This, of course, depends upon whether an automated verification approach is the preferred validation method.

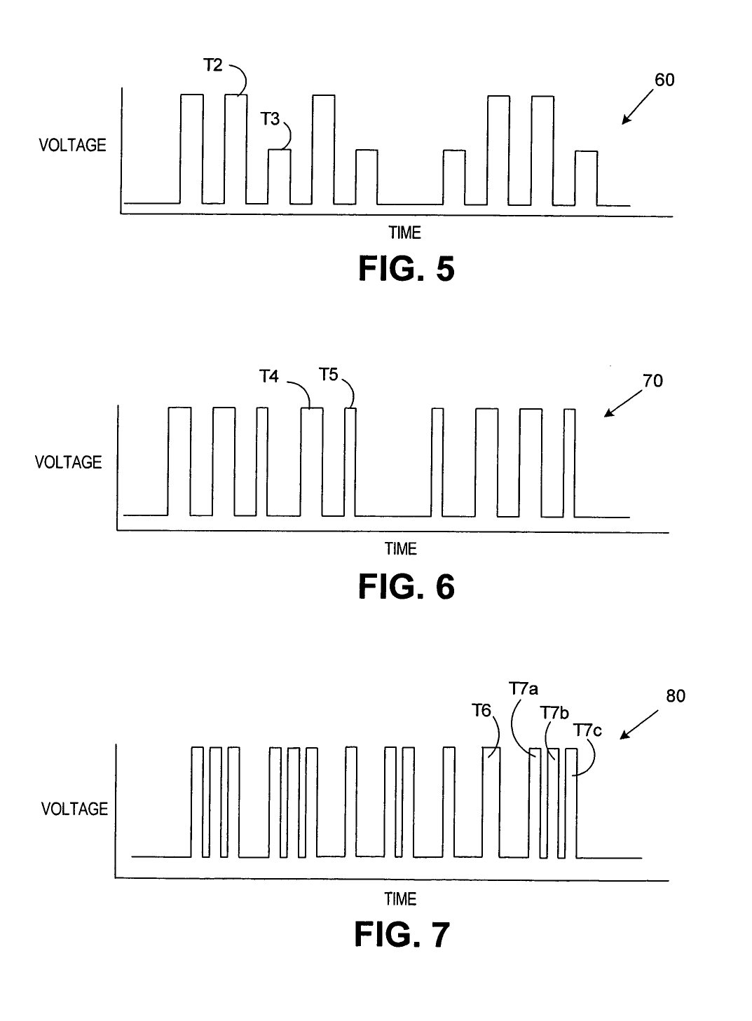

In step B of FIG. 2, the impact printer 10 is controlled in a manner which replicates the encoded image 40. More specifically, and referring additionally to FIGS. 1 and 5, the controller 22 of the impact printer 10 effects a variation in the magnetic field strength or magnetic flux density [i.e., the magnetic field strength (H) and flux density (B) are related/proportional to the magnetization (M) of an object and the permeability of free space (μ₀)] the is proportional to produced by the solenoids 20. Accordingly, by controlling the magnetic flux of the solenoids 20, the impact pressure applied by the impact pins 14 on the print ribbon 16 may be controlled. In one embodiment of the method, the magnetic flux produced by the solenoids 20 may be varied by a change in voltage across the solenoid 20. That is, the rate of displacement, i.e., velocity, of the impact pin 14 may be increased or decreased by variation of the voltage across the solenoids 20. As such, the impact pressure applied to the print ribbon 16 varies to produce pixels 30D, 30L of variable pixel density, i.e., black or X % gray-scale. More specifically, the pixel density may vary from full pixel density to a reduced percentage thereof. A full density pixel may be as dark as the print ribbon 16 allows while a pixel of reduced density may be one which is 50%, of the full pixel density, e.g., 50% gray-scale assuming that black ink is employed.

FIG. 5 shows a histogram 60 of voltage vs. time and how voltage may be varied by the controller 22 (FIG. 1) to produce the desired printing effect. In the described embodiment, twenty-four (24) volts is typically applied to a solenoid 20 to produce a dark or substantially black ink dot or pixel. By reducing the voltage, i.e., below normal fluctuations which may result from variability in manufacturing, the density of select pixels within the encoding scheme may be reduced. For example, at time T2, an unspecified voltage level across a solenoid produces a pixel having essentially full color density, i.e., is as dark as the print ribbon will allow. At time T3, a voltage, lower than the voltage applied at time T2, to the same or different solenoid, produces a pixel having less color density or some percentage, e.g., 50%, of the full color density. While the voltage at one point in time is shown to be approximately ½ the value at another, it should be appreciated that the histogram 60 is merely demonstrating the requirement to control voltage, not the requisite voltage to print a pixel in accordance with the present invention.

In another embodiment of the method, the magnetic flux density produced by the solenoids 20 may be varied by a change in the pulse width or duration of the voltage applied to the solenoids 20. That is, the time that the impact pin 14 contacts the print ribbon 16 may be increased or decreased by varying the duration of the voltage pulse. As such, the impact pressure is applied to the print ribbon 16 for a longer or shorter period to produce a pixels 30D, 30L of variable pixel density, i.e., black or X % gray-scale.

FIG. 6 shows a histogram 70 of voltage vs. time and how the pulse width of the voltage may be varied by the controller 22 to produce the desired print effect. In the described embodiment, a voltage pulse width of between about 0.2-0.4 ms is typically applied to a solenoid 20 to produce a dark or substantially black ink dot or pixel. By reducing the pulse width, i.e., below normal fluctuations which may result from variability in manufacturing, the density of select pixels within the encoding scheme may be reduced. For example, at time T4, an unspecified pulse width applied to a solenoid produces a pixel having essentially full color density, i.e., is as dark as the print ribbon will allow. At time T5, the duration of the pulse width is decreased, to the same or different solenoid, to produce a pixel having a lower density or some percentage, e.g., 50%, of the full density. While the pulse width at one point in time is shown to be approximately ½ the pulse width at another, it should be appreciated that the histogram 70 is merely demonstrating the requirement to control the duration of the pulse width and not the precise duration or relative duration of a pulse to print a pixel in accordance with the teachings of the present invention.

In yet another embodiment of the method, the magnetic flux density produced by the solenoids 20 may be varied by a changing the frequency of pulses applied to the solenoids 20. That is, the number of times the impact pin 14 contacts the print ribbon 16 in a prescribed period may be increased or decreased by modulating the frequency of the pulse. As the number of pulses increases (i.e., the number of times the impact pin 14 touches the print ribbon 16), the pixel density increases.

FIG. 7 shows a histogram 80 of voltage vs. time wherein the frequency of pulses is varied to produce the desired print effect. For example, at time T6, a single pulse is applied to a solenoid (i.e., within an unspecified time period) to produce a pixel having a first density. At times T7a, T7b, T7c, collectively representing the same time period as the previous increments of time, three pulses are generated to produce a pixel having essentially full color density, i.e., is as dark as the print ribbon will allow. Consequently, the pixel produced at time T6 will be lighter than the pixel produced over a period spanning T7a-T7c

In step C, the image is printed in accordance with the indexing function, i.e., binary string of data, described above in FIG. 3. As such, the density of each pixel is determined by the indexing function. To avoid the possibility that variations in pixel density, i.e., due to current fluctuations arising from manufacturing tolerances or small deviations in controller output, the density variation from one pixel to another should be greater than the sum of three standard deviations of a light density pixel and three standard deviations of a dark or full density pixel. Such variation may be necessary to ensure that verification or validation of the original image may be performed both manually and automatically.

In step D, the original image of FIG. 3 may be examined manually, i.e., by the eyes of an inspector, or automatically using a scan of the image 40. For manual validation that an original printed image is authentic, the inspector is provided a display or visual replication of the encoding scheme, i.e., showing the location of the light and dark density pixels. The inspector compares at least a subset of the pixels in the image being examined to determine when it is an original/authentic image or a copy/fraudulent image.

Automatic verification proceeds in a similar manner but with the aid of a computer processor (not shown) to produce a bitmap of the scanned image. In substep D1, the processor reconstructs the indexing function and identifies the available pixels based upon the encoding scheme and any predetermined rules established for selecting available pixels (such rules may also be viewed as being a component of the encoding scheme). It will be recalled that one such rule, discussed previously, related to the elimination or exclusion of peripheral pixels in the print grid, i.e., the first and last columns/rows C1, C9, R1, R21 of the grid shown in FIG. 3. In substep D2, the image is examined by the processor to determine which pixels are lighter or darker in pixel density and, in substep D3, the pixel density is checked or compared for consistency between the bitmap values obtained during scanning and the binary string of data associated with the encoding scheme. This check may comprise (a) verifying that the pixels encode the correct information (b) applying an error correction value to correct for any incorrectly read bits of the scanned original image, and/or (c) verifying a cryptographic signature, Message Authentication Code (MAC), truncated MAC or other authentication code for the retrieved bitmap.

In summary, the method of the present invention enables fraud detection features to be incorporated into a printed image for authenticating purposes. The fraud detection features are incorporated by encoding an image using pixels of varying pixel density. The invention also discloses simple modifications to the controller of the impact printer to produce pixels of varying density, i.e., via variation in voltage amplitude or pulse width. Furthermore, the invention enables authentication by automated scanning equipment.

The method utilizes an impact printer which may be generally characterized by low cost and high reliability. The impact printer has the capability to print through multi-sheet forms or documents. It will be appreciated that the impact pins of the print head can produce sufficient impact force to traverse the thickness of two or more sheets. Therefore, in addition to providing an encoded image/message, the impact printer can provide a receipt or evidence of the printed image/message. For example, when producing an image such as postal indicia, it may be necessary to retain or produce a receipt of the indicia for tax or other purposes.

It is to be understood that the method of the present invention is not to be considered as being limited to the specific embodiments described above and shown in the accompanying drawings. The embodiments described herein merely illustrate the best mode presently contemplated for carrying out the invention and are susceptible to such changes as may be obvious to one skilled in the art. Accordingly, the invention is intended to cover all such variations, modifications and equivalents thereof as may be deemed to be within the scope of the claims appended hereto.

What is claimed is:

1. A method comprising the steps of:
providing an impact printer having a print ribbon disposed between a print head and a substrate material, the print head including a plurality of impact pins each being disposed within a corresponding electrically activated solenoid, each solenoid producing a magnetic flux density for displacing the respective impact pin into contact with the print ribbon, thereby producing a respective printed pixel on the substrate material; and
selectively controlling the magnetic flux density produced by each solenoid to control a respective print density of each of the respective printed pixels,
wherein the respective printed pixels define a printed image and at least some of the respective print densities of each of the respective printed pixels are different from each other to define an encoding scheme within the printed image.

2. The method according to claim 1 wherein the magnetic flux density is controlled by varying a voltage level across each solenoid.

3. The method according to claim 1 wherein the magnetic flux density is controlled by varying the width of a voltage pulse applied to each solenoid.

4. The method according to claim 1 wherein the magnetic flux density is controlled by modulating the frequency of a voltage pulse applied to each solenoid.

5. The method according to claim 1 wherein the pixel density varies from a value ranging from full pixel density to a percentage of the full density.

6. The method according to claim 1 wherein the encoding scheme is produced by the substeps of:
identifying the available pixels to be encoded in a print grid;
indexing the available pixels from a binary string of data; and
determining the density of each available pixel based on the binary string of data.

7. An apparatus for producing an image having an authenticating encoding scheme therein, comprising:
a print head having a plurality of impact pins and a print ribbon disposed between the plurality of impact pins and a substrate material, each impact pin being disposed within a corresponding electrically activated solenoid, the solenoids each producing a magnetic flux density for displacing the respective impact pin into contact with the print ribbon, thereby producing a respective printed pixel on the substrate material, and
a controller for selectively controlling the magnetic flux density produced by the each solenoid to control a respective pixel density of each of the respective printed pixels,
whereby at least some of the respective print densities of each of the respective printed pixels are different from each other to produce the authenticating encoding scheme within the image.

8. The apparatus according to claim 7 wherein the controller varies a voltage level across each solenoid to vary the magnetic flux density.

9. The apparatus according to claim 7 wherein the controller varies the width of a pulse applied to each solenoid to vary the magnetic flux density.

10. The apparatus according to claim 7 wherein the controller modulates the frequency of a pulse applied to each solenoid to vary the magnetic flux density.

11. A method for determining the authenticity of an original image, comprising the steps of
providing an impact printer having a print ribbon disposed between a print head and a substrate material, the print head including a plurality of impact pins each being disposed within a corresponding electrically activated solenoid, each solenoid producing a magnetic flux density for displacing the respective impact pin into contact with the print ribbon, thereby producing a respective printed pixel on the substrate material,
printing the original image by incorporating a predefined encoding scheme within the image, the predefined encoding scheme characterized by selectively controlling the magnetic flux density produced by each solenoid of the impact printer to control a respective print density of each of the respective printed pixels, at least some of the respective print densities of each of the respective printed pixels being different from each other, and
examining the original image for evidence of the predefined encoding scheme and authenticating the original image when the prescribed pixel density of the original image corresponds to the pixel density of the predefined encoding scheme.

12. The method according to claim 11 wherein the magnetic flux density is controlled by varying a voltage level across each solenoid.

13. The method according to claim 11 wherein the magnetic flux density is controlled by varying a voltage pulse applied to each solenoid.

14. The method according to claim 11 wherein the magnetic flux density is controlled by modulating the frequency of a voltage pulse applied to each solenoid.

15. The method according to claim 11 wherein the predefined encoding scheme is produced by the substeps of:
identifying the available pixels to be encoded in a print grid;
indexing the available pixels from a binary string of data; and
determining the density of each available pixel based on the binary string of data.

16. The method according to claim 15 wherein the step of examining the original image includes the substeps of:
scanning the printed image to produce a bitmap thereof; and
comparing the bitmap of the original image to the binary data string of the encoding scheme.
